(19) United States
(12) Patent Application Publication
(10) Pub. No.: US 2008/0190712 A1
(43) Pub. Date: Aug. 14, 2008

(54) Brake Pad with Identification Means and System and Method for the Identification of Brake Pads

(75) Inventor: Yngve Hagberg, Goteborg (SE)

Correspondence Address: WRB-IP LLP, 1217 KING STREET, ALEXANDRIA, VA, 22314, US

(73) Assignee: VOLVO LASTVAGNAR AB, Göteborg (SE)

(21) Appl. No.: 11/911,381

(22) PCT Filed: Apr. 20, 2006
(86) PCT No.: PCT/SE2006/000470

§ 371 Date: Oct. 12, 2007

(30) Foreign Application Priority Data
Apr. 21, 2005 (SE) 0500905-5

(51) Int. Cl. F16D 66/02; F16D 65/092

(52) U.S. Cl. 188/1.11 L; 188/250 R

(57) ABSTRACT

A brake pad for a vehicle includes a back plate and a lining made of a friction material, and the lining includes a wireless identification device adapted to identify the brake pad. The brake pad enables wireless identification of brake pads and also makes it possible to obtain a wireless signal when the brake pad is worn a predefined quantity.

The present invention relates to a brake pad with identification means, a system for the identification of brake pads and a method for the identification of brake pads. This brake pad arrangement is suitable for identifying a brake pad and also for detecting the wear of a brake pad.

In modern vehicles, there are many functions that are specific on a certain vehicle. This depends e.g. on how the vehicle is specified. This specification can in turn influence the driving parameters of the vehicle. In order to use the right set-up parameters for a specific vehicle, it is important that the system of the vehicle can detect the components that influence the parameter set-up. One example of this is an automatic gearbox that will adapt its gear shift parameters depending on if a trailer is present or not, and also depending on the weight of the trailer.

Another component that can affect the driving parameters of the vehicle is the type of brake pad used. It may be possible to equip the vehicle with two or more different brake pad types, depending on e.g. the intended use of the vehicle and/or the brake discs used. A vehicle used on a construction site can be equipped with brake pads having a higher wear resistance but a slightly lower friction coefficient. A distribution vehicle can on the other hand be equipped with brake pads having a high friction coefficient but a lower wear resistance. There may also be other types of brake pads, adapted e.g. for wet, hot or cold conditions.

When using different types of brake pads, it is of utmost importance that the system of the vehicle has information of the type of brake pad used in order to set the proper parameters for the brake system. If a vehicle is set up for one type of brake pads and at the same time uses a different type of brake pad, the braking efficiency may be affected in a negative way.

There are a number of possible ways to register the type of brake pad to the system of the vehicle. One way is to let the person installing or changing the brake pads insert the type of the new brake pads into the system via a service computer or via the menu system in the vehicle's information system. This method is time consuming and also not very reliable.

Another way, suitable for brake pads with conventional wear detection in the form of a wire that wear off, is to use different resistors in series with the detection wire for different brake pads. This type of detection is costly and requires that the brake pad is connected to the system with a connector.

It is desirable therefore to provide a brake pad with an identification means which is cheap and reliable, a reliable system for the identification of brake pads and a reliable method for the identification of brake pads.

According to an aspect of the present invention, with a brake pad for a vehicle, comprising a back plate and a lining made of a friction material, the lining comprises a wireless identification means adapted to identify the brake pad.

By this first embodiment of the brake pad according to an aspect of the invention, a wireless identification of a brake pad is obtained. This allows for an easy and reliable identification of brake pads, either of the same or different types.

In an advantageous further development of the brake pad according to an aspect of the invention, the identification means is positioned at a predefined distance from the back plate of the brake pad, which will cause the identification means to break when the lining is worn a predefined quantity. The advantage of this is that a wear signal is obtained.

In an advantageous further development of the brake pad according to an aspect of the invention, the identification means comprises a further component arranged to wear off before the identifications means itself. The advantage of this is that a further wear signal is obtained.

In the first embodiment of an aspect of the system for the identification of brake pads on a vehicle, the system comprises a plurality of brake pads with wireless identification means, a receiver arranged to receive identification numbers from the identification means and a memory where the identification numbers of the mounted brake pads are stored. In this way, the system can detect and identify each individual brake pad mounted on the vehicle. By comparing the identification numbers received from the identification means with the identification numbers stored in the memory, the system can also detect brake pads that do not respond to the receiver. Brake pads that do not respond, i.e. do not emit their identification number, are worn more than a predefined quantity.

The first embodiment of an aspect of the method for the identification of brake pads comprising identification means, includes the steps of energising the identification means with an electromagnetic field, reading the identification number signals emitted from the identification means in the brake pads with a wireless receiver, comparing each emitted identification number with a plurality of identification numbers stored in a memory. By doing this, it is possible to detect if an identification means in a brake pad is emitting a signal or not. When an identification means is not emitting a signal, it can be assumed that the brake pad is worn down so that the identification means is broken, which indicates that the brake pad is worn a predefined quantity.

In an advantageous further development of the method, a message is stored in a memory and/or displayed when a stored identification number is not among the emitted identification numbers. The advantage of this is that the need to replace brake pads on the vehicle can be monitored.

### BRIEF DESCRIPTION OF DRAWINGS

The invention will be described in greater detail in the following, with reference to the embodiments that are shown in the attached drawings, in which

FIG. 1 shows a brake pad according to an aspect of the invention,

FIG. 2 shows a side view of a brake pad according to an aspect of the invention, and

FIG. 3 shows an embodiment of a brake pad according to an aspect of the invention.

### DETAILED DESCRIPTION

The embodiments of aspects of the invention with further developments described in the following are to be regarded only as examples and are in no way to limit the scope of the protection provided by the patent claims. In the following, a brake pad for disc brakes is described as an example of an aspect of the invention. Aspects of invention are also applicable on brake shoes for drum brakes.

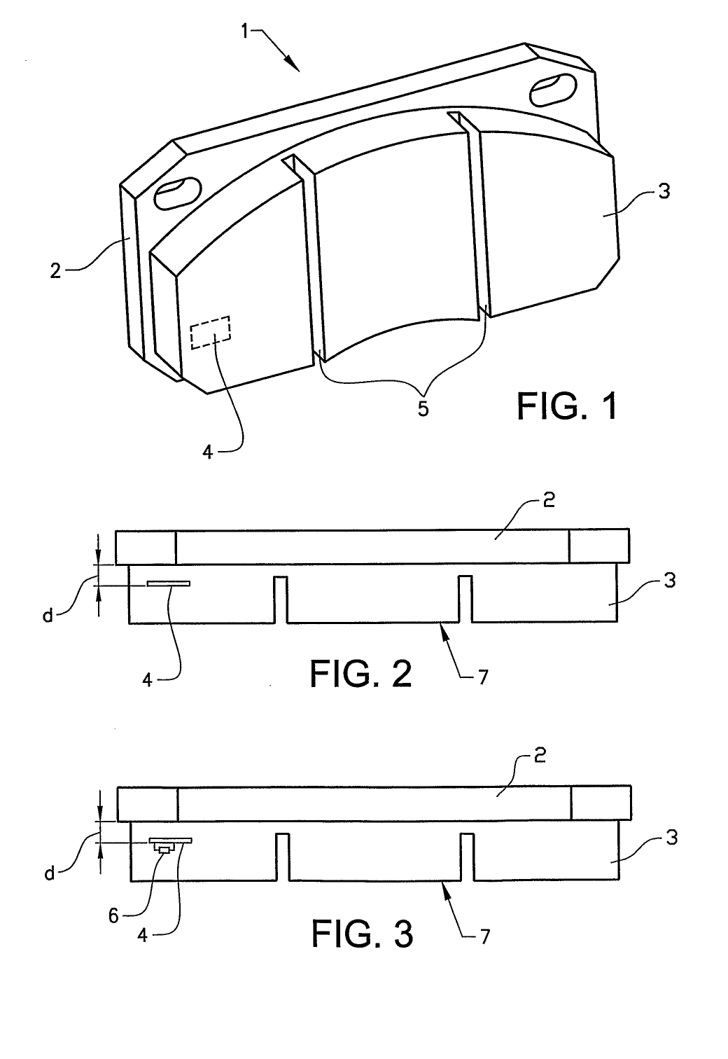

FIG. 1 shows a brake pad 1 made up of a back plate 2 and a brake lining 3. The back plate is a rigid steel plate and the brake lining is bond to the steel plate in a known manner. The brake lining is made of a suitable friction material. In this example, the brake lining comprises two grooves 5. The contact surface of the brake pad, i.e. the surface contacting the brake disc, is denoted 7.

An identification means 4 is included in the brake lining. The identification means 4 can be fastened to the outside of the brake lining or be integrated into the brake lining.

The identification means 4 is wireless. Preferably, the identification means 4 is a passive radio tag. These radio tags are known as RFID-tags (RFID=Radio Frequency Identification) or RFID-transponders. An RFID-tag comprises an RFID-chip comprising an identification number and an antenna. The passive RFID-tag is energised by an electromagnetic field which is sent out from a RFID-receiver. When the transponder is energised, it will send out its identification number. The identification number is then read by the RFID-receiver. The RFID technology is well-known to the skilled person and is not described in further detail.

In FIG. 2, a side view of the brake pad is shown. Here, the identification means 4 is integrated into the friction material.

A vehicle equipped with brake pads including identification means will now be described.

The brake pads are mounted to the vehicle when the vehicle is assembled in the factory plant. During the assembly, the position of each individual brake pad is stored in the vehicle system. This can be done in different ways. One way is to use a small, hand-held receiver with a limited reading distance. When all brake pads are assembled, the reader is used to read each individual brake pad and at the same time, the position of each brake pad is determined. It is also possible to use an automatic system set up in the workshop that can detect the identification number and the position at the same time. Depending on the RFID- receiver system on the vehicle, it is also possible to detect the position of a brake pad with the system built into the vehicle. It is not necessary to know the exact position of each brake pad, i.e. on which side of the brake disc each brake pad is positioned. Depending on the vehicle, it is sufficient to know either at which wheel the brake pad is mounted, at which axle the brake pad is mounted or if the brake pad is mounted on a front or a rear axle of the vehicle.

After assembly, the type of brake pads that are installed and the position of each individual brake pad are stored in a memory in the vehicle. This is advantageous e.g. if the vehicle is equipped with different brake pads on different axles. A vehicle can for example have different brake pads on the front axle and the rear axle/s. In this way, it is possible for the vehicle system to set the right brake parameters for each axle depending on the used brake pads.

When the vehicle is started, that is when all the systems on the vehicle are powered up, different checks and initiations are performed. During each start up, or on a regular basis, the vehicle system will read the identification number from each brake pad. The detected brake pad identification numbers are compared with the stored identification numbers to see if all the stored brake pad identification numbers are detected. If an identification number is missing, an error code can be stored and/or an error message can be displayed.

The RFID-tag is preferably positioned on or in the brake pad in a predetermined fashion. By placing the RFID-tag at a predefined distance d from the back plate in the brake lining, the disappearance of an identification number can be used as a wear sensor for the brake pad. When the brake lining is worn down to the position where the RFID-tag is positioned, the RFID-tag will break. When the RFID-tag breaks, the identification number for that specific brake pad will disappear from the list of brake pads detected by the RFID-receiver. Thus, the system will know that the specific brake pad has worn a certain quantity and has a certain life left before it needs replacement. The estimated time left before the brake pad needs to be replaced can be stored in a memory and/or displayed as a message.

When an identification number for a brake pad disappears, the system can perform a plausibility check to see if it is likely that a brake pad is worn down to the RFID-tag. If the identification number disappears much earlier than expected, it is likely that another fault has occurred. Either the brake itself is defect, e.g. the brake jams causing the brake pad to wear quicker than expected, or the RFID-tag itself is defect. These faults can also be stored and/or displayed as a message.

During use of the vehicle, the brake pads will wear more and more, and thus more identification numbers will disappear from the list of present brake pads. In this way, the system can determine when the brake pads on the vehicle or on each axle need replacement. The estimated time for the replacement can be stored in the system's memory. This estimation can be used to make sure that the brake pads are changed during a regular service.

This information can also be used to adapt the brake force applied to each axle of the vehicle. If, for example, the system detects that the brake pads on the front axle has worn faster than the brake pads on the rear axle/s, the system can modify the brake ratio between the front axle and the rear axle/s so that the estimated remaining life time for all brake pads is the same.

In one embodiment, only the identification number for each brake pad, and not the position, is stored in the systems memory. This can be sufficient if only one type of brake pads is used for the complete vehicle. In this way, the number of present identification numbers is compared with the number of brake pads on the vehicle. When a predefined number of brake pad identification numbers have disappeared, a message can be given that the brake pads need replacement.

The use of a specific identification number for each brake pad is also advantageous in respect to the safety of the vehicle. The identification number can be a randomly selected unique number for each brake pad, or it can comprise two or more sub-numbers. In one embodiment, the first sub-number comprise f the brake pad type number, i.e. indicates which type of brake pad it is, and the second sub-number is the unique identification number. In this way, the system can detect that the right brake pad type is used.

The system can also detect if a fake or counterfeit brake pad is used. In this way, it is possible to make sure that the vehicle meets the specifications guaranteed by the manufacturer in respect to braking. False brake pads can affect the brake capacity of a vehicle severely. This detection can be done in several ways. If a person tries to use brake pads without an RFID-tag, the system will detect this. One possibility is in this case to restrict certain driving parameters in order to make sure that the vehicle is safe despite the fact that the system does not know what type of brake pads are mounted on the vehicle. It is for example possible to limit the available power of the engine or the maximum allowed speed.

If the counterfeit brake pads are equipped with an identification number, it is possible for the system to send a list of detected brake pad identification numbers to a central station, e.g. by a built in phone, in order to compare the identification numbers with manufactured identification numbers. This also allows for the detection of different brake pads with identical identification numbers.

Since brake pads heat up during use, it is advantageous to read the identification numbers when the brake pads are cold. This is often the case when the vehicle is started, but for e.g. a distribution vehicle, it is possible that the brake pads are warm when the vehicle is started. The reading may therefore be done when the vehicle has been standing still for a predefined time. It is not necessary to do the reading every time the vehicle is started, but the reading is preferably done on a regular basis, either in time or in driving distance.

In a further embodiment, the identification means comprises means for changing the resonance frequency. Normally, an RFID-tag has a fixed resonance frequency made up by a resonant LC-circuit. By adding an extra component, the resonance frequency can be changed. An example of this is shown in FIG. 3, where an extra capacitor 6 is added to the RFID-tag. The capacitor 6 is positioned at a small distance from the rest of the RFID-tag. In this way, the extra capacitor will be positioned closer to the contact surface 7 of the brake pad than the rest of the RFID-tag. When the brake pad is worn down to the capacitor 6, the capacitor will break. This will alter the resonance frequency of the RFID-tag, which enables the system of the vehicle to determine that the brake pad is worn. The RFID-receiver operates in this example with two frequencies, one to detect the RFID-tags with the extra capacitor intact, and one to detect the RFID-tags where the extra capacitor is worn off.

In this way, it is possible to detect two different levels of wear for the brake pad. One level where the extra capacitor is worn off, and one level where the RFID-tag itself is worn off. The extra component can be any component that allows for a change in the resonance frequency, depending on the design of the RFID-tag.

Depending on the RFID-reader system, one or more antennas are used on the vehicle. With more antennas, it is also possible to detect the position of a brake pad.

An aspect of the invention also relates to a method for the identification of brake pads comprising wireless identification means on a vehicle. This is done by energising the identification means comprised in the brake pads with an electromagnetic field. The signal emitted from the identification means is read with a wireless receiver. This signal corresponds to an identification number that identifies the specific brake pad. Each received identification number is compared with identification numbers stored in a memory in the system of the vehicle. The stored identification numbers corresponds to the identification numbers of the brake pads mounted on the vehicle. The stored identification numbers preferably comprise the unique identification number for each mounted brake pad. The stored identification numbers can also be just the type or types of brake pads used or a combination of both.

Every received identification number is compared with the stored identification numbers. When a received identification number matches a stored identification number, this number is deleted from a temporary list comprising all the stored identification numbers. When all the received identification numbers have been compared with the identification numbers in the temporary list, the numbers that match have been deleted from the list. That is, the numbers corresponding to the brake pads identified by the system are deleted from the list. If the list is empty, all brake pads where detected which means that all brake pads are within the predefined limit.

If there are identification numbers left in the list, the brake pads corresponding to the identification numbers are worn down to the predefined thickness. In this case, an error message is created. The message can be stored in a memory, together with e.g. time information. When the vehicle is on a regular service, the information can be collected by the service technician.

If it is estimated that the brake pad should be replaced before the regular service, a message can be given to the driver that the brake pad is worn and/or needs to be replaced. A message can also be given when a certain quantity of brake pads are not detected.

Since the brake pads heat up during use, it is advantageously to perform the identification of brake pads when the brake pads are cold. When the brake pads are to hot, the RFID-tags may not function properly and/or the response frequency may shift outside of the receivers detection range. This can be done by performing the method when the vehicle is started, or when the vehicle is started after a longer still-stand. The detection may be performed on a regular basis, e.g. every week or after every 1000 km driving distance.

The invention is not to be regarded as being limited to the embodiments described above, a number of additional variants and modifications being possible within the scope of the subsequent patent claims.

1. Brake pad for a vehicle, comprising a back plate and a lining made of a friction material, wherein the lining comprises a wireless identification means adapted to identify the brake pad and the identification means contains an individual identification number.

2. Brake pad according to claim 1, wherein the identification means is integrated into the friction material of the brake pad.

3. Brake pad according to claim 1, wherein the identification means is positioned at a predefined distance from the back plate of the brake pad.

4. Brake pad according to claim 1 wherein the identification means is arranged in the lining such that it is broken when the lining is worn a predefined quantity.

5. Brake pad according to claim 1 wherein the identification means contains information regarding a type of friction material in the lining.

6. Brake pad according to claim 1 wherein the identification means comprises a further component arranged between the identifications means and a contact surface of the brake pad.

7. System for the identification of brake pads on a vehicle, wherein the system comprises a plurality of brake pads with wireless identification means, a receiver arranged to receive individual identification numbers from the identification means and a memory where the identification numbers of the mounted brake pads are stored.

8. System according to claim 7, wherein the system further comprises means for comparing the identification numbers received from the identification means with the identification numbers stored in the memory.

9. System according to claim 8, wherein the system further comprises means for storing or displaying a message when an identification number received from the identification means is not among the identification numbers stored in the memory.

10. Vehicle comprising a system according to claim 7.

11. Method for the identification of brake pads, comprising:
energising wireless identification means comprised in the brake pads with an electromagnetic field,
reading an identification number signals emitted from the identification means in the brake pads with a wireless receiver, and
comparing each emitted identification number with at least one identification number stored in a memory.

12. Method according to claim 11, further comprising storing a message in a memory when a stored identification number is not among the emitted identification numbers.

13. Method according to claim 12, further comprising giving a message to the driver that a brake pad is worn.

14. Method according to claim 11, wherein the method is performed when a vehicle, on which the brake pads are mounted, is started.

15. (canceled)

16. Computer program product comprising program code stored on a medium that can be read by computer for carrying out the method in claim 11 when the program is executed by a computer.

17. Use of a wireless identification means containing an individual identification number to identify a brake pad for a vehicle.
